(19) United States
(12) Patent Application Publication
(10) Pub. No.: US 2017/0280691 A1
(43) Pub. Date: Oct. 5, 2017

(54) MULTILAYER ARTIFICIAL HONEYCOMB

(71) Applicant: Kai Ching LOU, Hong Kong (HK)

(72) Inventor: Kai Ching LOU, Hong Kong (HK)

(21) Appl. No.: 15/350,108

(22) Filed: Nov. 14, 2016

(30) Foreign Application Priority Data
Apr. 5, 2016 (HK) 16103849.9

(51) Int. Cl. A01K 47/04; A01K 47/06

(52) U.S. Cl. CPC A01K 47/04; A01K 47/06

(57) ABSTRACT

A multilayer artificial honeycomb is disclosed, which comprises an operation module, a honeycomb module and a honey-storing module which are arranged from top to down; wherein the honeycomb module is connected to and driven by the operation module; the honeycomb module communicates with the honey-storing module; the honeycomb module includes a lattice assembly, beeswax and propolis; the lattice assembly is moved by an external force applied to the operation module, in such a way that honey inside the multilayer artificial honeycomb flows downwardly into the honey-storing module. The multilayer artificial honeycomb of the present application can be used for a long period of time, omitting the steps in the traditional honey gathering processes, reducing cost, simplifying the process, and meanwhile avoiding disturbance to normal activities of bees; therefore, beekeeping can be widespread, and the global ecological balance can be maintained.

### CROSS-REFERENCE TO RELATED APPLICATIONS

This application claims priority benefit of Hong Kong Patent Application No. 16103849.9 with a filing date of Apr. 5, 2016. The content of the aforementioned application, including any intervening amendments thereto, are incorporated herein by reference.

### TECHNICAL FIELD

The present application relates to the technical field of honeycomb, and more particularly, the multilayer artificial honeycomb.

### BACKGROUND OF THE PRESENT INVENTION

Traditional honey gathering processes are extremely complicated, during which a beekeeper needs to wear protective clothing, and further carry out processes including smoking bees, opening the beehive, cleaning, sweeping the bees, cutting the honeycomb, and extracting honey. During the honey gathering processes, the beekeeper and the bees are prone to harm, bee larvae are prone to die, and the harvest is likely to be reduced. Furthermore, the expansion of beekeeping is limited due to the high cost of the honey gathering processes and the high dependence on experience.

### SUMMARY OF PRESENT INVENTION

The objective of the present application is to provide multilayer artificial honeycomb, which eliminates the drawbacks of the prior process described above.

In accordance with one aspect of the present application, a multilayer artificial honeycomb is provided, which comprises an operation module, a honeycomb module and a honey-storing module which are arranged from top to bottom; wherein the honeycomb module is connected to and driven by the operation module; the honeycomb module communicates the honey-storing module; the honeycomb module includes a lattice assembly, beeswax and propolis; the lattice assembly is moved by an external force applied to the operation module, in such a way that honey inside the multilayer artificial honeycomb flows downwardly into the honey-storing module.

In one embodiment, the lattice assembly includes an M by N matrix array of lattices, wherein M and N both are positive integers.

In one embodiment, every two adjacent rows of lattices are drawn together and arranged side by side.

In one embodiment, each lattice, the propolis and the beeswax produced during the nest building processes carried out by bees, together form a honeycomb lattice.

In one embodiment, the lattice module is made of plastic.

In one embodiment, a gap is formed between two adjacent rows of lattices.

In one embodiment, the gap is filled with the propolis and the beeswax.

In one embodiment, the operation module is an operating handle; the honey-storing module is a honey-storing container formed by splicing a plurality of components together.

In accordance with a further aspect of the present application, a multilayer artificial honeycomb is further provided, which comprises an operation module, a honeycomb module and a honey-storing module which are arranged from top to bottom; wherein the honeycomb module is connected to and driven by the operation module; the honeycomb module communicates with the honey-storing module; the honeycomb module includes a lattice assembly, beeswax and propolis; the lattice assembly is moved by an external force applied to the operation module, in such a way that honey inside the multilayer artificial honeycomb flows downwardly into the honey-storing module; the lattice assembly includes an M by N matrix array of lattices, wherein M and N both are positive integers; every two adjacent rows of lattices are drawn together and arranged side by side; each lattice, and the propolis and the beeswax produced during the nest building processes carried out by bees together form a honeycomb lattice; the lattice module is made of plastic; a gap is formed between two adjacent rows of lattices; the gap is filled with the propolis and the beeswax; the operation module is an operating handle; the honey storing module is a honey-storing container formed by splicing a plurality of components together.

In accordance with a further aspect of the present application, a multilayer artificial honeycomb is further provided, which comprises an operation module, a honeycomb module and a honey-storing module which are arranged from top to bottom; wherein the honeycomb module is detachably connected to and driven by the operation module; the honeycomb module communicates with the honey-storing module; the honeycomb module includes a lattice assembly, beeswax and propolis; the lattice assembly is moved by an upwardly pulling force applied to the operation module, in such a way that honey inside the multilayer artificial honeycomb flows downwardly into the honey-storing module; the lattice assembly includes an M by N matrix array of lattices, wherein M and N both are positive integers; every two adjacent rows of lattices are drawn together and arranged side by side; each lattice, and the propolis and the beeswax produced during the nest building processes carried out by bees together form a honeycomb lattice; the lattice module is made of plastic; a gap is formed between two adjacent rows of lattices; the gap is filled with the propolis and the beeswax; the operation module is an operating handle; the honey-storing module is a honey-storing container formed by splicing a plurality of components; the honey-storing container has an outlet through which honey flows out of the multilayer artificial honeycomb together.

When implementing the technical solution of the present application, the multilayer artificial honeycomb of the present application can be used for a long period of time, omitting the steps in the traditional honey gathering processes, reducing cost, simplifying the process, and meanwhile avoiding disturbance to normal activities of bees. Therefore, beekeeping can be widespread, and the global ecological balance can be maintained.

### DESCRIPTION OF THE DRAWINGS

The present application will be further described with reference to the accompanying drawings and embodiments in the following; in the accompanying drawings:

FIG. 1 is an explored view of a multilayer artificial honeycomb according to a first embodiment of the present application;

FIG. 2 is an assembled view of the multilayer artificial honeycomb shown in FIG. 1;

FIG. 3 is a schematic view of the multilayer artificial honeycomb shown in FIG. 2 after a nest is built by bees;

FIG. 4 is a side view of the multilayer artificial honeycomb shown in FIG. 3 after the nest is built;

FIG. 5 is a further side view of the multilayer artificial honeycomb shown in FIG. 3 after the nest is built;

FIG. 6 is an explored view of a multilayer artificial honeycomb according to a second embodiment of the present application; and

FIG. 7 is an explored view of a multilayer artificial honeycomb according to a third embodiment of the present application.

### DETAILED DESCRIPTION OF PREFERRED EMBODIMENTS

The objective, the features and the characteristic of the present application, the operation method and the function of relative components and the combination of the components in structure will become more evident with reference to the accompanying drawings, the specific embodiments and the claims, It should be explicitly understood that, the accompanying drawings are only for description and illustration, and not for limitation to the present application.

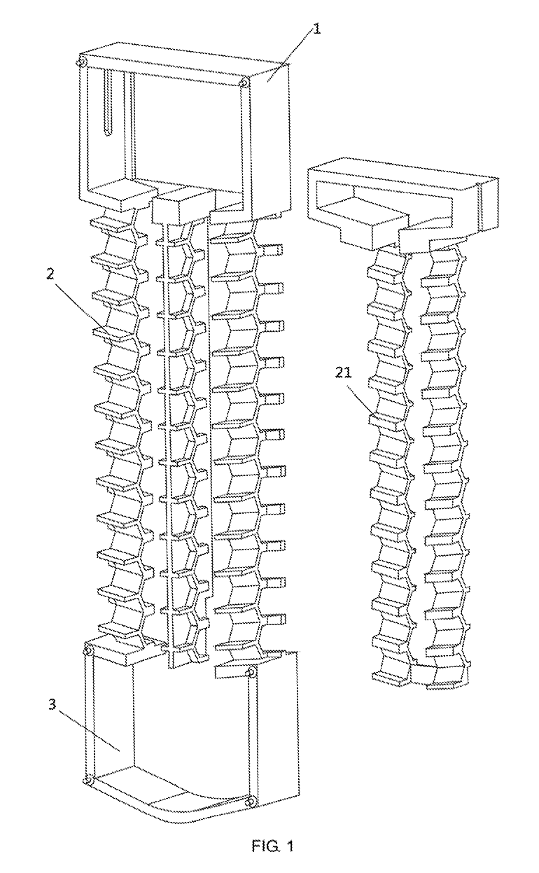

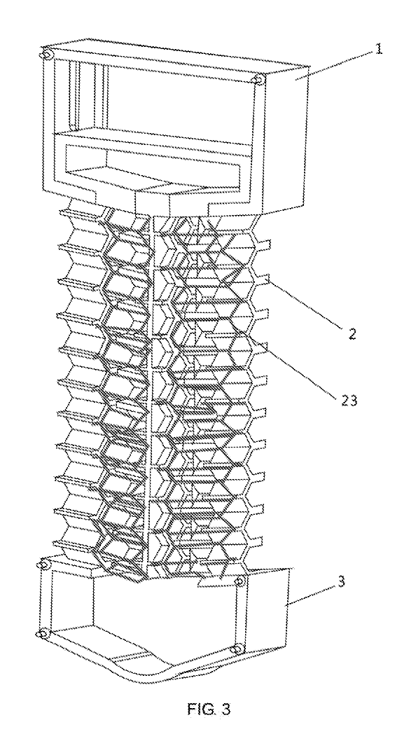

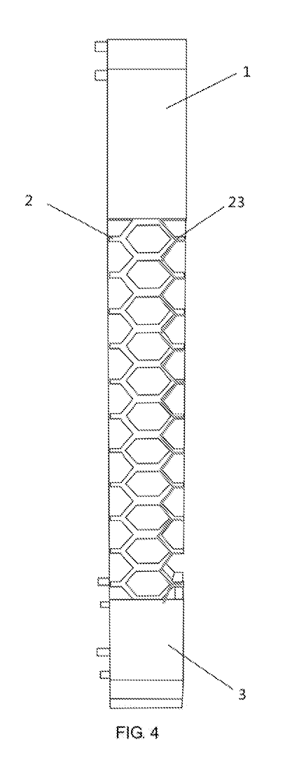

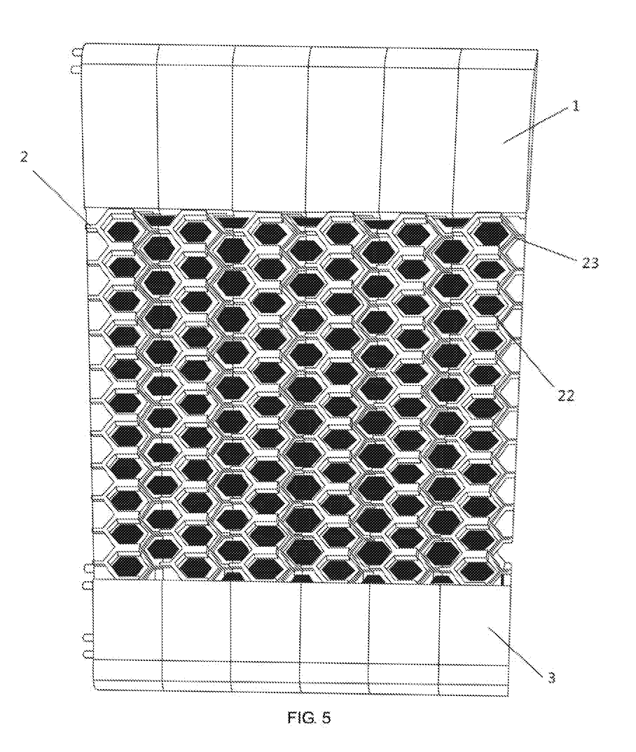

FIGS. 1-5 show a multilayer artificial honeycomb according to a first embodiment of the present application. As is shown in FIG. 1, the multilayer artificial honeycomb comprises an operation module 1, a honeycomb module 2 and a honey-storing module 3 which are arranged from top to bottom. In this case, the honeycomb module 2 is detachably connected to and driven by the operation module 1; that is, the operation module 1 and the honeycomb module 2 are two independent components which can be assembled with each other, and an external force applied to the operation module 1 can be transmitted to the honeycomb module 2. The honeycomb module 2 communicates with the honey-storing module 3; that is, passages allowing honey 22 to flow through are formed between the honeycomb module 2 and the honey-storing module 3, and the honey 22 may flow from the honeycomb module 2 to the honey-storing module 3.

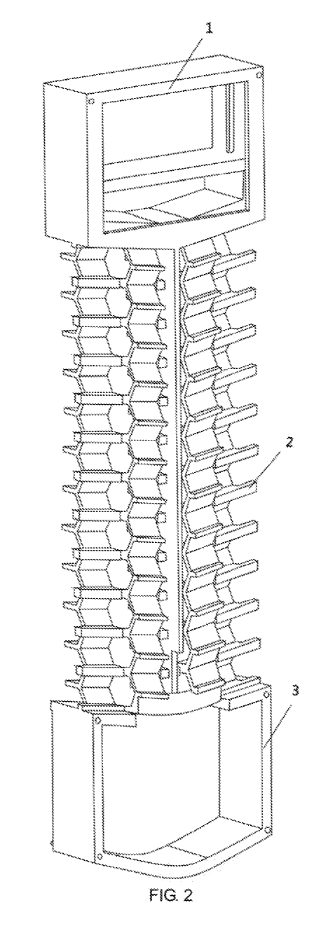

As is shown in FIGS. 1-5, the honeycomb module 2 includes a lattice assembly 21, beeswax and propolis. The lattice assembly 21 is moved by an upwardly pulling force applied to the operation module 1; in this way, the honey inside the multilayer artificial honeycomb flows downwardly into the honey-storing module 3. The lattice assembly includes an M by N matrix array of lattices. In this case, M and N both are positive integers. That is, the lattice assembly may be expanded as required, As is shown in FIG. 2, every two adjacent rows of lattices are drawn together and arranged side by side, and every two rows of the lattices are movable with respect to each other. Each lattice, the propolis and beeswax 23 produced during the nest building processes carried out by bees together form a complete honeycomb lattice. The lattice module 2 is made of plastic or other materials. A gap is formed between two adjacent rows of lattices, and the gap is filled with the propolis and the beeswax 23. It is possible for the operation module 1 to be an operating handle in such a way that it can facilitate the application of external forces. The honey-storing module 3 is a honey-storing container formed by splicing a plurality of components together. The honey-storing container has an outlet through which the honey 22 flows out of the multilayer artificial honeycomb.

Every two rows of lattices of the lattice assembly are initially movable with respect to each other, and gaps are formed between every two adjacent rows of lattices. Parts of walls of the honeycomb are absent initially. In this way, a honeycomb lattice having a prototype of honeycomb but not complete is formed, The honeycomb lattice at this stage is configured for inducing the bees to build a nest, and to complete the honeycomb with the propolis and the beeswax. Then the bees build the nest and store honey therein. After the honey is stored in the honeycomb, the lid of a beehive is sealed. When gathering the honey, if any lattice assembly is pulled in the operation module 1, then the movement of the lattice assembly tears the honeycomb formed by the beeswax and the propolis and tears the gaps from the inner side of the honeycomb; the honey 22 in turn flows from the gaps to the honey-storing module 3 below, and further flows out of the beehive via the outlet. Meanwhile, the lid can be kept well sealed on the beehive, since no assembly on the surface of the honeycomb moves.

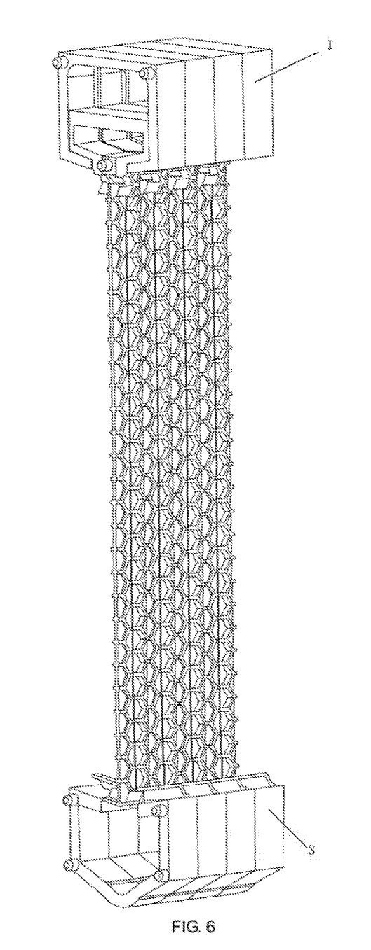

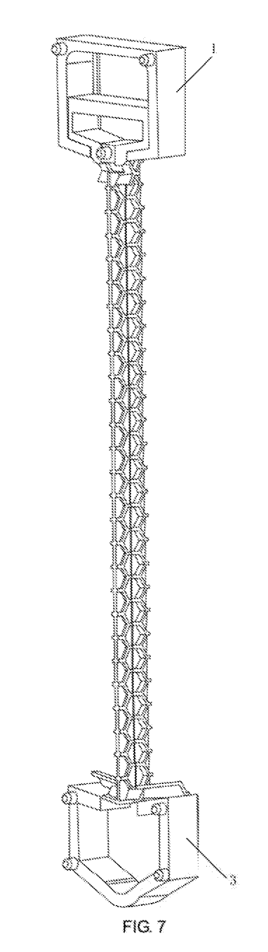

In addition, in the embodiment shown in FIGS. 6 and 7, the lattice assembly may be moved vertically or horizontally.

Those described above are only preferred embodiments of the present application, and are not for limitation. Those skilled in the art may make many alternatives or modification to the embodiments, according to the disclosure and motivation of the specification. All the modifications, alternatives or improvements made in the inspiration of the present application should fall in the protection scope of the claims of the present application.

I claim:

1. A multilayer artificial honeycomb, comprising an operation module, a honeycomb module and a honey-storing module which are arranged from top to bottom; wherein the honeycomb module is connected to and driven by the operation module; the honeycomb module communicates with the honey-storing module; the honeycomb module includes a lattice assembly, beeswax and propolis; the lattice assembly is moved by an external force applied to the operation module, in such a way that honey inside the multilayer artificial honeycomb flows downwardly into the honey-storing module.

2. The multilayer artificial honeycomb according to claim 1, wherein the lattice assembly includes an M by N matrix array of lattices. wherein M and N both are positive integers.

3. The multilayer artificial honeycomb according to claim 2, wherein every two adjacent rows of lattices are drawn together and arranged side by side.

4. The multilayer artificial honeycomb according to claim 2, wherein each lattice, the propolis and the beeswax produced during the nest building processes carried out by bees together form a honeycomb lattice.

5. The multilayer artificial honeycomb according to claim 1, wherein the lattice module is made of plastic.

6. The multilayer artificial honeycomb according to claim 2, wherein a gap is formed between two adjacent rows of lattices.

7. The multilayer artificial honeycomb according to claim 6, wherein the gap is filled with the propolis and the beeswax.

8. The multilayer artificial honeycomb according to claim 1, wherein the operation module is an operating handle; the honey-storing module is a honey-storing container formed by splicing a plurality of components together.

9. A multilayer artificial honeycomb, comprising an operation module, a honeycomb module and a honey-storing module which are arranged from top to bottom; wherein the honeycomb module is connected to and driven by the operation module; the honeycomb module communicates with the honey-storing module; the honeycomb module includes a lattice assembly, beeswax and propolis; the lattice assembly is moved by an external force applied to the operation module, in such a way that honey inside the multilayer artificial honeycomb flows downwardly into the honey-storing module; the lattice assembly includes an M by N matrix array of lattices, wherein M and N both are positive integers; every two adjacent rows of lattices are drawn together and arranged side by side; each lattice, the propolis and the beeswax produced during the nest building processes carried out by bees together form a honeycomb lattice; the lattice module is made of plastic; a gap is formed between two adjacent rows of lattices; the gap is filled with the propolis and the beeswax; the operation module is an operating handle; the honey storing module is a honey-storing container formed by splicing a plurality of components together.

10. A multilayer artificial honeycomb, comprising an operation module, a honeycomb module and a honey-storing module which are arranged from top to down; wherein the honeycomb module is detachably connected to and driven by the operation module; the honeycomb module communicates with the honey-storing module; the honeycomb module includes a lattice assembly, beeswax and propolis; the lattice assembly is moved by an upwardly pulling force applied to the operation module, in such a way that honey inside the multilayer artificial honeycomb flows downwardly into the honey-storing module; the lattice assembly includes an M by N matrix array of lattices, wherein M and N both are positive integers; every two adjacent rows of lattices are drawn together and arranged side by side; each lattice, the propolis and the beeswax produced during the nest building processes carried out by bees together form a honeycomb lattice; the lattice module is made of plastic; a gap is formed between two adjacent rows of lattices; the gap is filled with the propolis and the beeswax; the operation module is an operating handle; the honey storing module is a honey-storing container formed by splicing a plurality of components: the honey-storing container has an outlet through which honey flows out of the multilayer artificial honeycomb together.
